(19) United States
(12) Patent Application Publication
(10) Pub. No.: US 2003/0098856 A1
(43) Pub. Date: May 29, 2003

(54) Selective ambient light attenuating device and associated emissive display

(76) Inventor: Zili Li, Barrington, IL (US)

Correspondence Address: MOTOROLA, INC., 1303 EAST ALGONQUIN ROAD, IL01/3RD, SCHAUMBURG, IL, 60196

(21) Appl. No.: 09/996,133

(22) Filed: Nov. 28, 2001

(51) Int. Cl. G09G 5/00

(52) U.S. Cl. 345/173

(57) ABSTRACT

A selective ambient attenuating device and associated display attenuates light reflected from an emissive display during bright ambient light conditions (280). A selective polarizer (210) is positioned above the emissive display (230). A quarter wave plate (220) is disposed between the selective polarizer (210) and the emissive display (230). A photo sensitive device (250) detects the ambient light condition and causes the selective polarizer (210) to transition between a transparent state to a linearly polarizing state and block reflected ambient light when the photo sensitive device detects high ambient light conditions. The quarter wave plate (220) is preferably disposed between the selective polarizer (210) and the emissive display (230) but can be disposed between a reflective surface (240) and the emissive display (230).

### BACKGROUND OF THE INVENTION

1. Technical Field

The present invention relates to selective light attenuating devices and, more particularly, relates to selective ambient light attenuating devices to improve emissive display performance based on ambient light conditions.

2. Description of the Related Art

Currently most of handheld products use reflective liquid crystal displays (LCDs) for its power saving and sunlight readability. However, the reflective LCD suffers greatly from its poor visual performance under normal ambient lighting conditions. Under these conditions, it has poor color saturation, low brightness and poor contrast. Because of this, emissive displays such as OLED or transmissive LCD such as those in laptops have been gaining popularity. However, some the key problems with emissive displays in mobile application is their poor sunlight readability and their high current drain. Under strong ambient lighting conditions such as sunlight, the reflection of ambient light from various surfaces of an emissive display overwhelms the emitted image from the displays itself and renders the display hardly readable.

FIG. 1 illustrates a diagram of the operation of a prior art light emitting diode (LED) display. A light emitting diode display 110 is driven by a display driver 120 and emits light 150 in an upward and a downward direction. Its cathode acts as a reflective surface 130 below the light emitting diode 110 and reflects the downward directed light into the upward direction. A viewer 190 thus sees the light from the light emitting diode display 110.

FIG. 2 illustrates a diagram of the operation of a prior art light emitting diode display under high ambient light conditions. The light emitting diode display 110 still emits its light in an upward direction as reflected by the reflective surface 130 when driven by the display driver 120. Nevertheless, and high ambient light conditions, the sun 180 is relatively brighter and sunlight 170 is reflected off the reflective surface 130 and directed into the eye of the viewer 190. Although the viewer 190 receives the light 150 from the light emitting diode display 110, the reflective sunlight 170 is relatively brighter and makes viewing the display difficult or impossible.

Thus before the invention described herein, displays such as light emitting diode displays needed to be brighter than the brightness of ambient light conditions. A brighter light emitting diode display, however, required additional energy. Higher current loads on the batteries of portable devices such as cellular telephones reduce battery life. For emissive displays with a metallic cathode such as a Light Emitting Diode display, both inorganic and organic, this problem becomes much worse since a metallic surface, with it's mirror-like behavior, redirects close to 100% of the ambient light to the same direction as image to white out image.

Up to now there have been two primary ways attempting to mitigate this problem, however, both have a large penalty in terms of power consumption, a highly undesirable trade-off. A first way has been to increase the light output at high ambient condition to counterbalance the high ambient light reflection. In order to do this, a large increase in the driving current/voltage is needed for an emissive display and this results a large increase in power consumption of display.

Another way, based on the combination of a non-selective liner polarizer and quarter wave plate, has been used for rejecting the ambient light. Since the polarizer attenuates the light to half of its original level all the time, the display has to double its emission to maintain the same display brightness. For a device used mostly indoors with low ambient lighting conditions, it again substantially increase the display's power.

### SUMMARY OF THE INVENTION

A selective ambient attenuating device and associated display attenuates light reflected from an emissive display during bright ambient light conditions. A selective polarizer is positioned above the emissive display. A quarter wave plate is disposed between the polarizer and the display. A photo sensitive device detects the ambient light condition and causes the selective polarizer to transition between a transparent state to a linearly polarizing state and block reflected ambient light when the photo sensitive device detects high ambient light conditions. The quarter wave plate is preferably disposed between the selective polarizer and the emissive display but can be disposed between a reflective surface and the emissive display element.

The photo sensitive device can also act to decrease power to the emissive display when the photo sensitive device detects low ambient light conditions. The photo sensitive device can be a photovoltaic cell capable of generating a voltage to power the selective polarizer.

The details of the preferred embodiments of the invention may be readily understood from the following detailed description when read in conjunction with the accompanying drawings wherein:

### BRIEF DESCRIPTION OF THE DRAWINGS

FIG. 1 illustrates a diagram of the operation of a prior art light emitting diode display;

FIG. 2 illustrates a diagram of the operation of a prior art light emitting diode display under high ambient light conditions;

FIG. 3 illustrates a diagram of a selective ambient light attenuating device and an emissive display according to a first embodiment of the present invention;

FIG. 4 illustrates a diagram of a selective ambient light attenuating device and an emissive display according to a second embodiment of the present invention;

FIG. 5 illustrates a diagram of a selective ambient light attenuating device and an emissive display according to a third embodiment of the present invention;

FIG. 6 illustrates a detailed diagram of a selective ambient light attenuating device cooperating with an associated organic light emitting diode emissive display.

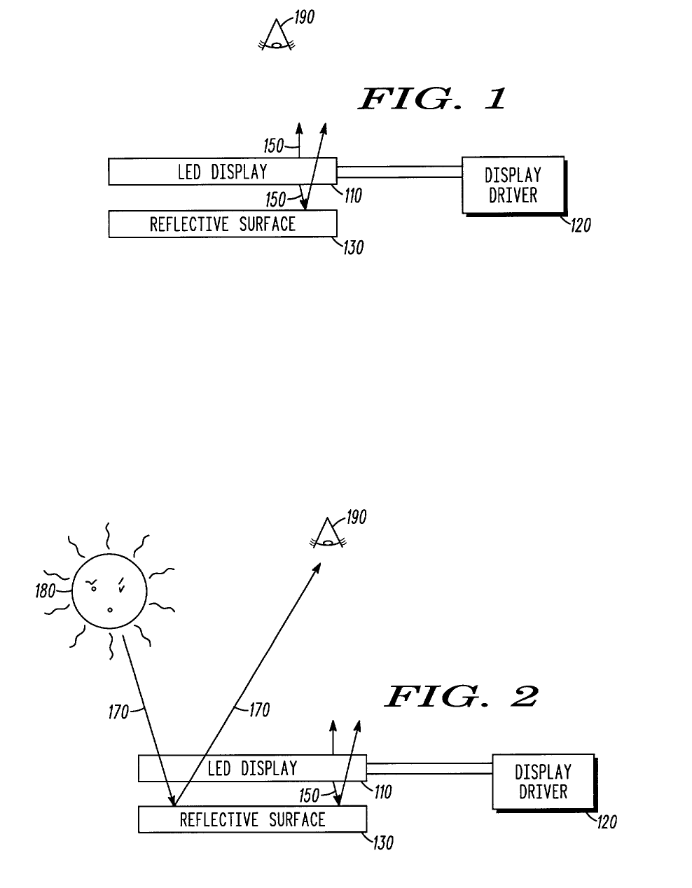

### DETAILED DESCRIPTION OF THE PREFERRED EMBODIMENTS

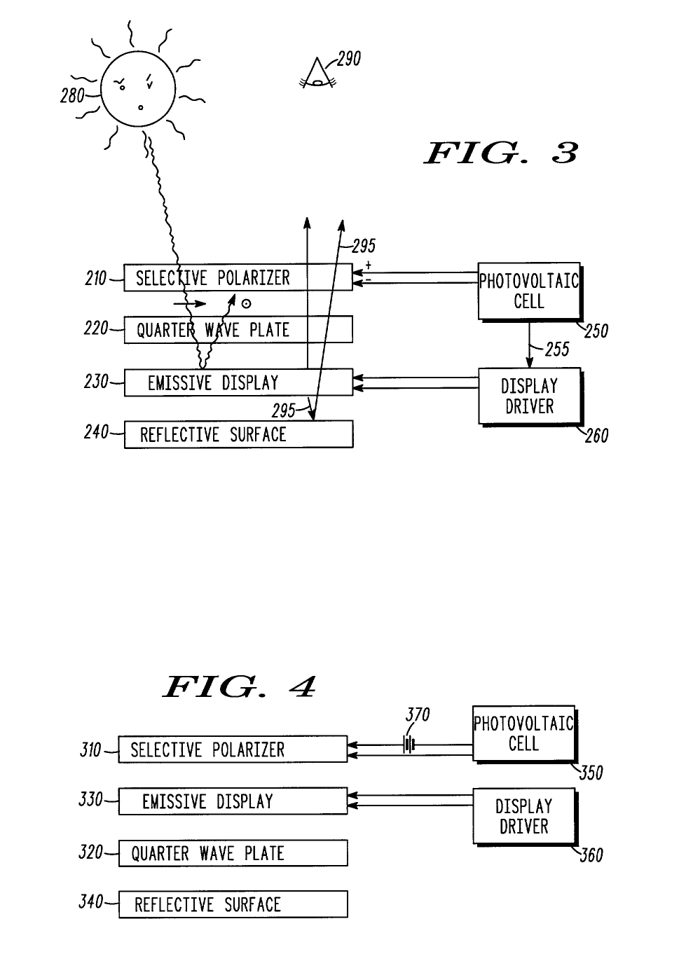

FIG. 3 illustrates a diagram of a selective ambient light attenuating device and an emissive display according to a first embodiment of the present invention. A selective polarizer 210 and a quarter wave plate 220 are disposed adjacent to an emissive display 230. The emissive display 230 is associated with a reflective surface 240 for reflecting light emitted from the emissive display. A photovoltaic cell 250 controls the polarization state of the selective polarizer 210 based on ambient light conditions. The emissive display 230 is driven by a display driver 260.

In low ambient light conditions, the voltage from the photovoltaic cell 250 is not sufficient enough to turn up the polarizing state of the selective polarizer 210. In a non-active state, the selective polarizer 210 is highly transparent so that both the ambient and emitted light from the emissive display 230 will pass without alteration of polarization state and with little attenuation. Thus the light emitted from the display does not suffer any loss. Moreover, since the selective polarizer 210 itself does not require any power in the non-active state, it does not draw any power from a battery of an associated portable device. The emissive display emits light 295 and an upward and a downward direction. The downward directed light is reflected by the reflective surface 240 and a viewer 290 views 100 percent (100%) of the light from the emissive display.

In high ambient light conditions, a photovoltaic cell 250 turns on the polarizing state of the selective polarizer 210. Bright sunlight 285 passes through the activated selective polarizer 210 and becomes linearly polarized. Thereafter the bright sunlight passes through the quarter wave plate 210 to become a circularly polarized light if the relative orientation of the selective polarizer 210 and the quarter waveplate 220 is set at approximately 45 degrees. After reflected from the reflecting surface, reflected light need to pass the quarter wave plate once more, the total half-wave phase shift after these two passes rotates the polarization of light to 90 degrees. When the reflected light re-enters the polarizer it is now perpendicular to the transmission axis of the polarizer, therefore it is attenuated before mixing with the image light from the emissive display. Therefore the sunlight 285 does not reach the viewer 290. The reflection occurs at any interface where exists a discontinuity of refractive index. However it occurs mostly at a metallic surface or electrodes that have a large refractive index. Even though a metallic mirrored surface is preferred, any reflective surface that maintains the phase of the incoming light will suffice. But even minor reflections off of the surfaces where refractive indices change between intermediate layers in a display structure will typically maintain phase of the incoming light. Reflections off of the electrodes within a display will usually maintain phase as well. Most surfaces meet this requirement and a special step in construction is not normally required.

In the high ambient light conditions, because the selective polarizer 210 is in a polarizing state, only 50% of the emitted light from the emissive display 230 reaches the viewer 290. In an alternate construction of the embodiments of the present invention, the display driver 260 can receive a signal 255 from the photovoltaic cell to increase the brightness of the emissive display when the selective polarizer 210 is driven in a polarizing state.

The photovoltaic cell 250 generates current to power the selective operation of the selective polarizer 210. Therefore, the selective ambient light attenuating device of the present invention is self powered and does not require an independent power source.

The emissive display 230 is a self-illuminated display such as a light emitting diode display (LED), an organic light emitting diode display (OLED), a backlit liquid crystal display (backlit LCD), an electro luminescent (EL) display, a cathode ray tube (CRT), a plasma display and a field emission display (FED).

Depending the electrical output of the photovoltaic cell, the polarizer transitions between a transparent state and a linearly polarizing state. The photosensitivity of the photosensitive device can be tailored to the applications to provide a desired degree of attenuating as the voltage from the photovoltaic cell increases.

For mobile communication devices such as cell phones, pagers, and personal digital assistants (PDAs) they are mostly used indoor with low ambient lighting conditions as comparing with the outdoor/sunlight condition. For these applications, we need to design this device not to draw any power from the device's limited power source, a battery in handheld device cases. At high ambient light conditions, the power output from the photosensitive device is large enough to power the selective polarizer to transition from the highly transparent state to the linearly polarizing state and to maintain at this state with this large ambient light condition. As the result, the overall device does not draw any power from the handheld device. Another advantage of this invention lies in its independent operation from the handheld device. This feature provides a paste-on solution to the problem and offers a much easier way to implementation due to little change in underlying display manufacture process.

One preferred way to fabricate device that satisfies the entire requirement is to use a liquid crystal/dye based polarizer in combination with a photovoltaic (solar) cell. Liquid crystal materials have been widely used today, mostly for display applications as in various types of liquid crystal displays seen in laptops and cell phones. For this application, the selective liner polarizer comprises a top and bottom substrates that contains the liquid crystal/dye material. Both inner surfaces of top and bottom substrates are coated with transparent conducting electrodes such as Indium-Tin-Oxide (ITO). The liquid crystal/dye material generally comprises a mixture of liquid crystal molecules and dye molecules. The dye in use should be dichroic, which means it absorption of light depends on its orientation to the incoming light. At low ambient light conditions, this device needs to be at non-powered state and non-absorbing (transparent) state to save power and to render good image. This can be achieved by setting the liquid crystal/dye mixture at homeotropic state, in which liquid crystal/dye mixture aligns perpendicular to the plane of substrates. A verity of surface alignment agents exist to provide such alignment as reported in prior art. As device moves into a high ambient condition, the large voltage output generated by the photovoltaic cell passes threshold of transition to turn liquid crystal/dye mixture from its perpendicular orientation to parallel orientation with respect to substrate plane if it has a negative dielectric anisotropy. The parallel orientation has absorption since the absorption axis of dye molecules is no longer in the same direction to the incoming ambient light. But to behave like a liner polarizer, a direction in the plane of the substrate has to be preset for liquid crystal/dye mixture to align in the plane along this direction, “polarization direction” of polarizer. A conventional mechanical rubbing process commonly used in fabrication of a liquid crystal display can be used.

The quarter wave plate can be either selective or non-selective. The described method can also be used to make a selective quarter wave plate by taking dichroic dye out of liquid crystal/dye mixture and adjusting its phase retardation value of a parallel aligned liquid crystal layer to a quarter wave phase retardation of the light.

The transition voltage of such liquid crystal polarizer or quarter wave plate is in range of 0.5-5 volts, a range very compatible with a photovoltaic cell.

FIG. 4 illustrates a diagram of a selective ambient light attenuating device and an emissive display according to a second embodiment of the present invention. A selective polarizer 310 and a quarter wave plate 320 are disposed adjacent to an emissive display 330. The quarter wave plate 320 is disposed on an opposite side of the emissive display 330 from the selective polarizer 310. The emissive display 330 is associated with a reflective surface 340 for reflecting light emitted from the emissive display. A photo detector 350 controls the polarization state of the selective polarizer 310 based on ambient light conditions. The emissive display 330 is driven by a display driver 360.

According to this second embodiment, the quarter wave plate 320 and the selective polarizer 310 are still adjacent to the emissive display 330, however, the quarter wave plate 320 is on an opposite side of the emissive display 330 from the selective polarizer 310. This second embodiment, however, is less desirable than the first embodiment because some reflection of ambient light will occur on the surface of the emissive display 330 and also because most commercially available emissive display contain an inherently built-in reflective surface. Thus, because a separate reflective surface element usually is not disposed beneath emissive display but instead is inherent within the emissive display, is preferable to place the selective polarizer and the quarter wave plate above the emissive display and the reflective surface.

The second embodiment of FIG. 4 uses a photo detector 350 instead of the photovoltaic cell 250 of the first embodiment of FIG. 3. Because the photo detector 350 does not generate voltage like the photovoltaic, a battery 370 is required to power the selective operation of the selective polarizer 310. Should a portable electronic device have its own power source, the battery 370 could be provided by the portable electronic device.

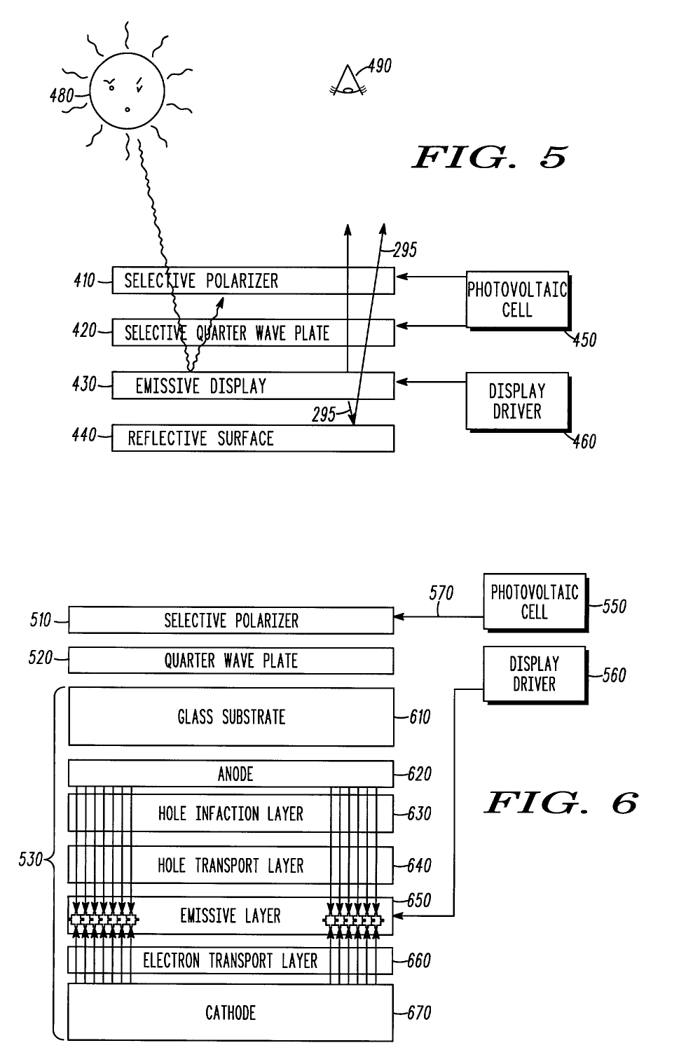

FIG. 5 illustrates a diagram of a selective ambient light attenuating device and an emissive display according to a third embodiment of the present invention wherein both a selective polarizer 410 and a selective quarter wave plate 420 are controlled by a photovoltaic cell 450 to enhance performance and simplify construction. The selective polarizer 410 and the selective quarter wave plate 420 are disposed adjacent to an emissive display 430. The emissive display 430 is associated with a reflective surface 440 for reflecting light emitted from the emissive display. The photovoltaic cell 450 controls the polarization state of the selective polarizer 410 based on ambient light conditions and at the same time controls the retardation sate of the selective quarter wave plate 420. Although only control of the retardation state of the selective quarter wave plate 420 is needed to attenuate ambient light transmission, it is preferred to control both the selective quarter wave plate 420 and the selective polarizer 410 if the polarizer is left continuously activated, the polarizer will absorb fifty percent (50%) of the light at the low ambient and reduce the brightness of the display. The selective quarter wave plate 420 is made in a similar fashion as the selective polarizer as described above with the exception of taking the dye out of the liquid crystal material. The emissive display 430 is driven by a display driver 460.

FIG. 6 illustrates a diagram of a selective ambient light attenuating device cooperating with an associated organic light emitting diode emissive display according to a third embodiment of the present invention.

A selective polarizer 510 and a quarter wave plate 520 are disposed adjacent to an organic light emitting diode emissive display 530. The organic light emitting diode emissive display 530 has an inherent built-in reflective surface 540 for reflecting light emitted within the emissive display. A photovoltaic cell 550 controls the polarization state of the selective polarizer 510 based on ambient light conditions. The organic light emitting diode emissive display 530 is driven by a display driver 560.

The organic light admitting diode emissive display 530 internally contains a glass substrate 610, an anode 620, a hole injection layer 630, a hole transport layer 640, an emitting layer 650, an electron transport layer 660 and a cathode 670. The 6 a cathode 670 acts as the reflective surface. A drive voltage such as about 5 Volts should be applied between the anode 620 and a cathode 670. The display driver 560 applies an electrical signal to the emitting layer 650 to drive the individual elements of the organic emitting diodes and form an image.

Although the invention has been described and illustrated in the above description and drawings, it is understood that this description is by example only, and that numerous changes and modifications can be made by those skilled in the art without departing from the true spirit and scope of the invention. Although the examples in the drawings depict only example constructions and embodiments, alternate embodiments are available given the teachings of the present patent disclosure. For example the emissive display could be miniature or room size. The drawings are for illustrative purposes and, although relative sizes can be seen among the elements, they are not drawn to scale.

What is claimed is:

1. A selective ambient light attenuating device for selectively attenuating light reflected from an emissive display, comprising:
a selective polarizer positioned above the emissive display;
a quarter wave plate disposed between the selective polarizer and the display; and
a photo sensitive device operatively coupled to the selective polarizer to detect the ambient light condition and cause the selective polarizer to transition between a transparent state to a linearly polarizing state and attenuate reflected ambient light when the photo sensitive device detects high ambient light conditions.

2. A selective ambient attenuating device according to claim 1, further comprising a reflective surface disposed below the emissive display.

3. A selective ambient attenuating device according to claim 2, wherein the reflective surface is a reflective surface with a characteristic that maintains a phase of incoming light.

4. A selective ambient attenuating device according to claim 1, wherein the emissive display is an emissive display unit that comprises at least one reflective surface.

5. A selective ambient attenuating device according to claim 4, wherein the at least one reflective surface is inherent in the construction of the emissive display.

6. A selective ambient attenuating device according to claim 1, further comprising a reflective surface in a separate layer below the emissive display.

7. A selective ambient attenuating device according to claim 1,
wherein the device further comprises a reflective surface disposed below the emissive display; and
wherein the quarter wave plate is disposed between the reflective surface and the display.

8. A selective ambient attenuating device according to claim 1, wherein the quarter wave plate is disposed between the selective polarizer and the display.

9. A selective ambient attenuating device according to claim 1, wherein the photo sensitive device decreases power of the emissive display when the photo sensitive device detects low ambient light conditions.

10. A selective ambient attenuating device according to claim 1, wherein the photo sensitive device is a photovoltaic cell capable of generating a voltage.

11. A selective ambient attenuating device according to claim 10, wherein an increase in the voltage from the photovoltaic cell is sufficient to cause an increase the polarization of the selective polarizer as ambient light conditions increase.

12. A selective ambient attenuating device according to claim 1, wherein the emissive display element is a self-illuminated display from the group consisting of a light emitting diode displays (LED), an organic light emitting diode displays (OLED), a backlit liquid crystal displays (backlit LCD), electro luminescent (EL) displays, cathode ray tubes (CRT), plasma displays and field emission displays (FED).

13. A selective ambient attenuating device according to claim 1, wherein the selective polarizer comprises a liquid crystal device.

14. A selective ambient attenuating device according to claim 1, wherein the quarter wave plate is a selective quarter wave plate that is selective between a transparent state and quarter wave phase retardation state.

15. A selective ambient attenuating device according to claim 14, wherein the selective quarter wave plate is transitioned by the photo detective element from a transparent state to a quarter wave state when the photo sensitive device detects high ambient light conditions.

16. A selective ambient light display, comprising:
an emissive display element;
a reflective surface disposed below the emissive display element; and
a selective polarizer positioned above the emissive display element; and
a quarter wave plate disposed between the selective polarizer and the reflective surface.

17. A selective ambient light display according to claim 16, wherein the quarter wave plate is disposed between the reflective surface and the display element.

18. A selective ambient light display according to claim 16, wherein the quarter wave plate is disposed between the selective polarizer and the display element.

19. A selective ambient light display according to claim 16, further comprising a photo sensitive device operatively coupled to the selective polarizer to detect the ambient light condition and cause the selective polarizer to transition between a transparent state to a linearly polarizing state and attenuate reflected ambient light when the photo sensitive device detects high ambient light conditions.

20. A selective ambient light display according to claim 19, wherein the photo sensitive device decreases power of the emissive display when the photo sensitive device detects low ambient light conditions.

21. A selective ambient light display according to claim 16, wherein the photo sensitive device is a photovoltaic cell capable of generating a voltage.

22. A selective ambient light display according to claim 21, wherein an increase in the voltage from the photovoltaic cell is sufficient to cause an increase the polarization of the selective polarizer as ambient light conditions increase.

23. A selective ambient light display according to claim 16, wherein the reflective surface is a mirror.

24. A selective ambient light display according to claim 16, wherein the reflective surface is inherent in the construction of the emissive display element.

25. A selective ambient light display according to claim 16, wherein the reflective surface is a separate layer below the emissive display element.

26. A selective ambient light display according to claim 16, wherein the emissive display element is a self-illuminated display from the group consisting of a light emitting diode displays (LED), an organic light emitting diode displays (OLED), a backlit liquid crystal displays (backlit LCD), electro luminescent (EL) displays, cathode ray tubes (CRT), plasma displays and field emission displays (FED).

27. A selective ambient light display according to claim 16, wherein the selective polarizer comprises a liquid crystal device.

28. A selective ambient attenuating device according to claim 16, wherein the quarter wave plate is selective between a transparent state and quarter wave phase retardation state.

29. A selective ambient light display, comprising:
an emissive display element;
a reflective surface disposed below the emissive display element; and
a selective polarizer positioned above the emissive display element;
a quarter wave plate disposed between the selective polarizer and the reflective surface; and
a photo sensitive device operatively coupled to the selective polarizer to detect the ambient light condition and cause the selective polarizer to transition between a transparent state to a linearly polarizing state and attenuate reflected ambient light when the photo sensitive device detects high ambient light conditions.
